(19) United States
(12) Patent Application Publication
(10) Pub. No.: US 2024/0066913 A1
(43) Pub. Date: Feb. 29, 2024

(54) Structure Staggered Wheels

(71) Applicant: Chet Redman Baigh, Chicago, IL (US)

(72) Inventor: Chet Redman Baigh, Chicago, IL (US)

(21) Appl. No.: 17/681,300

(22) Filed: Feb. 25, 2022

(51) Int. Cl. B60B 1/00

(52) U.S. Cl. CPC B60B 1/00; B60B 2900/311

(57) ABSTRACT

This embodiment of the present invention provides for a structure staggered set of four car wheels which achieves greater physical performance of the wheels of one axle by integrating additional structures. These structures would mainly be added to the face of the two wheels of a given axle. Further the structures may be added without largely departing from the stylistic arrangement of spokes found on the two wheels of another axle.

### BACKGROUND ART

### Information Disclosure Statement

Not Applicable

### Background of the Invention

An embodiment of the present invention as will be hereinafter referred to as “Structure Staggered Wheels” (SSW). An automotive (among others) industry exists wherein wheels are commonly made. The 4 car wheels are often the same size, width, and style. Other times the 4 wheels are staggered, in the traditional sense. Traditional staggering of a car's wheels means that the rear 2 wheels are larger in width and/or diameter than the front 2 wheels. This is most common on sports cars which have rear wheel drive. Other instances of the traditional staggered setup the rear wheels may be entirely different than the fronts. This is most common on dragsters which use huge rear tires for better rear wheel drive traction. The present invention of Structure Staggered Wheels (SSWs) do more than simply have a wider width or different diameter. SSW are also comprised of additional structural features on the rear wheels to add more lateral and torsional strength. The SSW are most beneficial for rear-wheel-drive cars, high horsepower cars, and/or mid-engine cars, but may be used with any cars or trucks. The structures may comprise a greater number of structural features on the face of the rear wheels as compared to the front wheels. Additionally, thicker structural features on the face or barrels of the rear wheels may also be added. As the design aesthetics of a set of wheels is important for marketability, the present invention comprises the additional advantage of maintaining the same general aesthetic style of wheel pattern on both the front and rear wheels.

### FIELD OF THE INVENTION

The present invention relates to a complete set of four automotive wheels which are made of solid materials which are not in tension like traditional bicycle spokes. Each automotive wheel is presumed to have a plurality of non-tensioned solid spokes (spokes) which create the structure and physical properties of the wheel. Secondarily, the spokes may be arranged, shaped and numbered so as to create a large variety cosmetic styles. One can observe that most all cars and consumers prefer wheels that are visually similar from front to back axles. The present invention of a structure staggered set of four car wheels achieves greater physical performance of the larger rear wheels by integrating additional structures. These structures would mainly be added to the face of the rear wheels. Further the structures may be added without largely departing from the front wheels in terms of style.

An embodiment of the present invention has a main object to provide a new and novel improved physical performance differentiation between the front and rear wheels of a car. Further, the invention provides for a commercially attractive ability to maintain a substantially similar style on the face between the front and rear wheels. As cars become more powerful, more physical force is applied to the wheels both in torsion and laterally. Most often, that force is delivered to the rear wheels of a car-thus necessitating improved performance of the wheel on the rear axle. Regardless of whether a car is all-wheel-drive, front-wheel-drive or rear-wheel-drive, the forces applied to the front wheels relative to the rear wheels is often different. The present invention improves the performance of a 4-wheel-set by accounting for the front-to-rear wheel differentiation of forces applied by strategically adding structural stylized forms to the face of either the front or rear wheels. The examples found herein will pertain to the adding of said structural stylized forms to the rear wheels, since that is most common arrangement. Further, the present invention also improves the 4-wheel-set by methodically achieving a commercially beneficial cosmetic style similarity between said front and rear wheels of a given 4-wheel-set. For the sake of this application, the example of a rear-wheel-drive car will be used henceforth. Generally, the additional structures added to the rear wheels' face would be additional spokes, however, increasing mass to aid the overall wheel's strength may include, but not be limited to the thickening of existing spokes or barrel components.

The manufacturing of wheels has for many years been a matter of economies of scale to make said wheels commercially economical. Technology has advanced such that different wheel designs can be quickly and efficiently changed on the basis of every-other wheel made. Thus, the adding of certain features to the face of a wheel becomes an economical method. While this application is not limited in scope to any one manufacturing method, a method of greatest advantage is that of a computer-guided CNC milling of forged wheel faces from a solid blank metal structure. Historically, forged wheel manufacturing has been very expensive. As costs decrease, a structure staggered set of wheels becomes more economically feasible.

### BRIEF DESCRIPTION OF THE DRAWINGS

FIG. 1 is a perspective view of a stylized front-axle vehicle wheel's front face;

FIG. 2 is a perspective view of a rear-axle vehicle wheel's front face which illustrates the additional structural features of the present invention on a wheel of corresponding style to that of FIG. 1;

FIG. 3 is a front elevation view of a stylized front-axle vehicle wheel's front face having an alternate general style than that of FIG. 1 and FIG. 2;

FIG. 4 is a front elevation view of a stylized rear-axle vehicle wheel's front face which illustrates alternate additional structural features of the present invention on a wheel of corresponding style to that of FIG. 3.

### DETAILED DESCRIPTION OF THE INVENTION

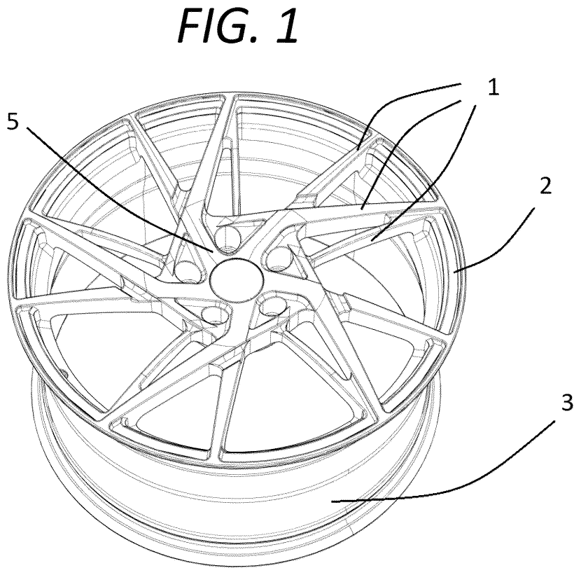

With reference to the drawings shown in FIGS. 1 to 4, the following description regards various example structures, systems, and methods. The systems, structures and methods illustrated comprise aspects of the invention which may be practiced. It is to be understood that other specific arrangements of parts, structures, examples, systems, and the like, may be utilized and structural and functional modifications may be made without departing from the scope of embodiments of the present invention. With reference to the drawings, and wherein the improvement comprises the methodical addition of stylized structural forms to the face of the wheels of either the front or rear axles independently so as to strengthen the said wheels of a given axle without greatly departing from the style of the full set of four wheels.

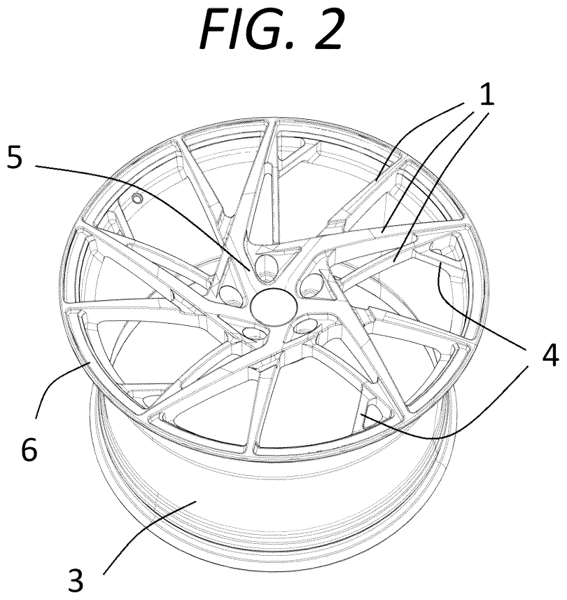

The embodiment of the present invention as comparatively illustrated in FIG. 1 generally illustrates an example front-axle automobile wheel 2. The front-axle automobile wheel 2 is one of a complete four-wheel-set having the other front-axle wheel comprised of the same number and mass of stylized structural forms. The two rear-axle wheels of this complete four-wheel-set are illustrated as rear-axle wheel 6 within FIG. 2. The front-axle wheel 2 illustrated has less physical stresses demanded and has a thin barrel width 3 as would be found on the front-axle wheels of a traditional four-wheel-set. The front-axle wheel 2 of FIG. 1 illustrates an exemplary and arbitrary style on the wheel face 5 comprising exemplary spokes 1 of a given shape, size and style.

FIG. 2 illustrates an exemplary rear-axle wheel 6 of a matching overall style face 5 to that of FIG. 1. Together, the front-axle wheel 2 of FIG. 1 and the rear-axle wheel of FIG. 2 would comprise example front-axle and rear-axle wheels of a full set of four wheels for a single car with an overall style commonality. The rear wheel 6 has a wider barrel 3 so as to put more tire and force onto the road when in use on the exemplary rear-wheel-drive car. Having only a wider rear wheel width is a traditional staggered arrangement. Given the additional torsional forces and lateral forces of the rear wheels, the spokes 1 would be under increased stress relative to that of the front wheel 2 of FIG. 1. As such an embodiment of the present invention comprises a plurality of additional stylized structural forms 4 to compensate for the increased forces and thus increase performance. The additional plurality of stylized structural forms 4 in this example, comprise solid spokes on the wheel face 5 which are also cohesive with the overall wheel style of the front-axle wheel 2 illustrated in FIG. 1.

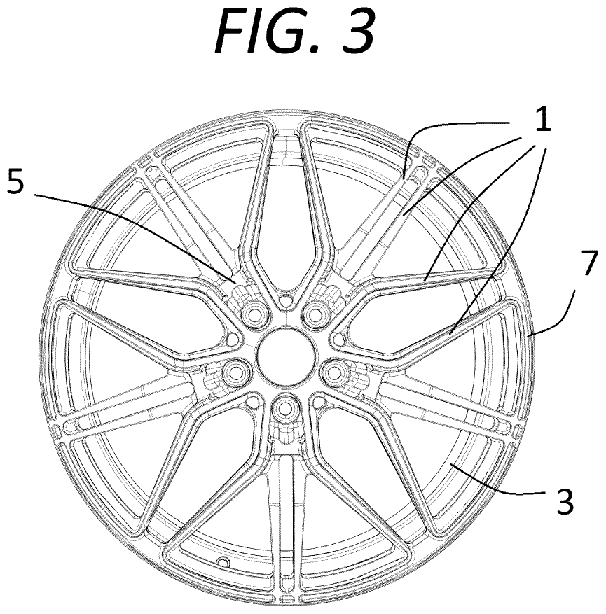

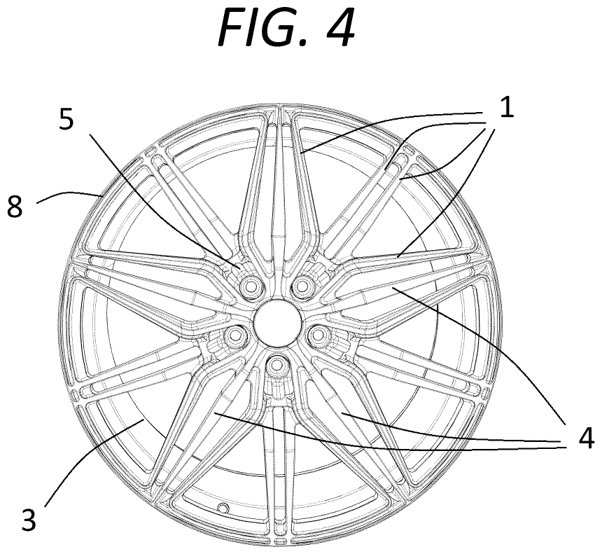

Given the present invention is additionally applicable to an infinite variety of wheel face 5 styles, FIG. 3 and FIG. 4 illustrate an embodiment of the present invention as it may relate to a distinctly different exemplary vehicle wheel face 5 style. Together, the front-axle wheel 7 of FIG. 3 and the rear-axle wheel 8 of FIG. 4 correspond to a complete four-wheel-set for a single car having matching wheels for the opposing end of a given axle. The embodiment of the present invention as comparatively illustrated in FIG. 3 generally illustrates an example front-axle automobile wheel 7. The front-axle wheel illustrated has less physical stresses demanded than the rear-axle wheel 8 illustrated in FIG. 4 and thus has a thin barrel width 3. The front-axle wheel 7 of FIG. 3 illustrates an additional exemplary and arbitrary style for the wheel face 5 comprising exemplary spokes 1 of a given shape, size and style.

FIG. 4 illustrates an exemplary rear-axle wheel 8 having a matching general style face 5 to that of front-axle wheel in FIG. 3. Together, the front-axle wheel 7 of FIG. 3 and the rear-axle wheel 8 of FIG. 4 would comprise example front and rear wheels of a full set of four wheels for a single car with a related style commonality. The rear wheel 8 has a wider barrel 3 so as to put more tire and force onto the road when in use on the exemplary rear-wheel-drive car. Having only a wider rear-axle wheel width is a normal staggered arrangement. Given the additional torsional and lateral forces of the rear-axle wheels 8, the spokes 1 would be under increased stress relative to that of the front-axle wheel 7 of FIG. 3. As such an embodiment of the present invention comprises a plurality of additional stylized structural forms 4 to compensate for the increased forces and thus increase structural performance. The additional plurality of stylized structural forms 4 in this example, comprise solid spokes on the wheel face 5 which are also cohesive with the overall wheel style of the front-axle wheel 7 illustrated in FIG. 3.

1. A complete set of automotive wheels having the two wheels of a single axle comprising a plurality of additional stylized structural forms on the face such that the said wheels provide greater structural strength than the wheels on another axle.

2. A method of strengthening the face of the two automotive wheels of a single axle while maintaining a substantially similar style among the wheel faces of all axles, comprising;
using computerized milling or mold-making technologies to add similar spokes adjacent to and/or connecting to the existing spokes of the wheels of the opposing axle to which less force is applied;
